(19) United States
(12) Patent Application Publication
(10) Pub. No.: US 2007/0092711 A1
(43) Pub. Date: Apr. 26, 2007

(54) Soft package

(75) Inventor: Thomas Daniel Arkins, Ridgefield, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignees: CONOPCO, INC.; d/b/a UNILEVER

(21) Appl. No.: 11/256,778

(22) Filed: Oct. 24, 2005

(51) Int. Cl. B32B 27/32; B32B 3/26; B32B 9/00

(52) U.S. Cl. 428/304.4; 428/516; 428/318.4

(57) ABSTRACT

A package wall is provided constructed from a first layer and a second layer. The first layer includes at least 50% polypropylene and from 7 to 30% talc. The second layer includes a foamed polypropylene. The wall has a soft powdery feel and retains a structural memory after being distortedly squeezed.

### BACKGROUND OF THE INVENTION

1. Field of the Invention

The invention concerns a laminate plastic construction particularly suitable for personal care products.

2. The Related Art

Purchase intent of consumer products is markedly increased by aesthetics of a package. First impression counts. Ornamental design, graphics and color all leave an important impression. Engineers have been working to constantly improve these features. Less traveled are the tactile aspects of consumer packaging.

Personal care products include those intended for skin, hair, dental and underarm applications. Many personal care products are packaged in trays or tubs. These are intended to hold individual sub units such as towelettes, dry cleansing cloths, swab sticks and related articles. Most often these are either packaged in cardboard or relatively rigid plastic walled containers.

Illustrative of the art is U.S. Pat. No. 6,520,331 B2 (Okin et al.). Therein is disclosed a relatively rigid tub identified as a dispensing article particularly for towelettes. The patent admits that considerable plastic is utilized for the container body. Therefore the container body is marketed as a non-disposible housing for an expendible low cost thermoform refill canister.

Multi-layered sheet materials are disclosed in U.S. Patent application 2004/0157051 A1 (Trent et al.). The sheets may be tray-shaped with layers of polypropylene, metallocene polypropylene and other thermoplastic materials.

U.S. Pat. No. 6,329,454 B1 (Krabbenborg) discloses a filled polypropylene composition exhibiting a good balance of stiffness and toughness to impart improved scratch resistance for injection molded articles. A variety of fillers including substantial amounts of talc may be formulated.

U.S. Pat. No. 6,495,249 B2 (Uchida et al.) discloses a layered material that includes a skin and a cushioning layer and/or a reinforcing layer. The material is described as light in weight, excellent in low-temperature resistance, relatively high in weathering resistance and environmentally friendly. Foamed polypropylene may constitute one of the layers of the material.

U.S. Patent application 2002/0039630 A1 (Rousselet et al.) discloses a tube or bottle for packaging household, food, chemical or cosmetic products. Walls of the container may be a blend of polypropylene homopolymer, a low density metallocene catalyzed polyethylene and optionally fillers such as talc. This material is engineered with a good breaking strength and is sufficiently axially rigid to withstand stacking as well as surviving being dropped from a significant height.

Unlike materials of the known art, the present invention seeks a packaging plastic which has a soft powdery feel. Moreover, the plastic upon being distorted through squeezing and gentle crushing must retain structural memory returning to its original shape.

### SUMMARY OF THE INVENTION

A package wall is provided which includes:
a first layer including at least 50% polypropylene and from 7 to 30% talc each by weight of the first layer; and
a second layer including a foamed polypropylene;
wherein the wall has a soft powdery feel and retains a structural memory after being distortedly squeezed.

Advantageously the first layer further includes a metallocene catalyzed polyethylene in an amount from about 5 to about 30%, preferably from about 15 to about 20% by weight of the first layer. Polypropylene may be present in amounts ranging from about 55 to about 75%, optimally from 60 to 70% by weight of the first layer. Most preferably, talc is present in an amount from about 10 to about 20%, optimally from about 16 to 18% by weight of the first layer.

The second layer is a polypropylene foamed with carbon dioxide and having a density ranging from about 0.3 to about 0.5 g/cm³, preferably from 0.36 to 0.42 g/cm³.

In a preferred embodiment, there will be a third layer which is a mixture of polypropylene and a low density polyethylene, each being present in a respective amount of from about 5:1 to about 1:5 by weight of the third layer.

The relative weights of the first and second layers may range from about 1:10 to about 1:2, optimally from about 1:6 to about 1:4. The first and third layers may be present in a relative weight ratio of about 1:2 to about 2:1, preferably about 1.2:1 to 1:1.2.

Talc is utilized for tactile purposes imparting a baby soft or powdery feel to the outer wall. Metallocene catalyzed polyethylene is utilized for its lower flow temperature (relative to non-metallocene polyethylene) serving as an adhesive component. The latter is important when covering an open mouth of a tray with a polyethylene film required to be bonded to the tray walls.

The foamed polypropylene second layer provides weight reduction to the wall and also imparts lattice strength and memory (snaps back to original shape after being squeezed).

### BRIEF DESCRIPTION OF THE DRAWING

Various features and advantages of the present invention will become further evident from consideration of the drawing in which:

FIG. 1 is a first embodiment of a package wall with a two-layer structure; and

FIG. 2 is a second embodiment of a package wall with a three-layer structure.

### DETAILED DESCRIPTION OF THE INVENTION

Now there has been found a laminate sheet for use as a package wall, particularly for personal care products, exhibiting improved properties. These include a soft powdery feel and anti-crushable property retaining structural memory after being distortedly squeezed.

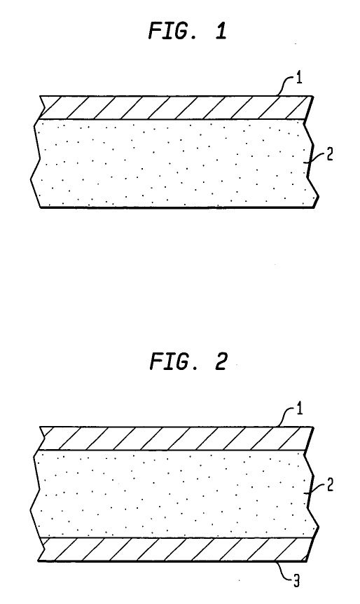

FIG. 1 illustrates a first embodiment with a first layer 1 and a second layer 2. The first layer by way of an example is a mixture of 60-70% polypropylene, 15-20% metallocene catalyzed polyethylene and 16-18% talc. Second layer 2 is a polypropylene foamed with carbon dioxide and having a density of about 0.44 g/cm³.

FIG. 2 illustrates a tri-layer laminate of the present invention. Herein the first layer 1 and the second layer 2 are identical with those described above in the context of FIG. 1. Additionally, there is a third layer which is a mixture of polypropylene and low density polyethylene (not of the metallocene type). All three layers are bonded together to form a single sheet. Relative weight amounts for the first, second and third layers are respectively about 15:70:15 in the exemplative and preferred embodiment of the laminates.

Commercially available talc useful in-this invention includes Microtuff® 121, sourced from Specialty Minerals of New York, N.Y.; and Prever® M8 and Jetfill® 675 C both sourced from Luzenac America of Englewood, Colo.

The second layer of the present invention will be a foamed polypropylene. Preferably the polypropylene will be physically foamed with a gas such as propane, nitrogen or carbon dioxide rather than an organic chemical foaming agent such as typically azodicarboxylic acid amide. Carbon dioxide is especially useful as the foaming agent. A suitable procedure for producing foamed polypropylene is described in US Patent application 2005/0006805 A1 (Sugihara et al.). The process therein describes injection-foaming a thermoplastic resin by using an injection molding machine with a two stage compression screw, the full disclosure being incorporated herein by reference. Other methods of preparing foamed polypropylene are found in US Patent application 2005/0056957 A1 (Hira et al.) and U.S. Pat. No. 5,180,571 (Park et al.) all of the aforementioned method disclosures are herein incorporated by reference.

The term “polypropylene” as employed herein can either refer to a homopolymer or a copolymer having a propylene content of at least 70 mole percent (preferably at least 80 mole percent). Advantageously the polypropylene is a homopolymer.

Foamed polypropylene used in the second layer may have a density which can range from 0.04 to 0.8 g/cm³, more preferably from 0.1 to 0.6, optimally from 0.3 to 0.5 g/cm³. Flexural moduli values may range from about 70 to about 2,000 MPa, preferably from about 90 to about 1,000 MPa, optimally from about 100 to about 350 MPa.

Thickness of the foamed polypropylene layer may range from about 0.1 to about 50 mil (0.0025-1.5 mm), preferably from about 1 to about 20 mil (0.025-0.50 mm), and optimally from about 5 to about 10 mil (0.125-0.25 mm).

Illustrative polypropylenes for use in the present invention are KF 6100 (Flexural Modulus, evaluated by ISO Standard Method 178, of about 1,300 MPa); Polypropylene YX 37F (Flexural Modulus of about 1,200 MPa); Adstif® 680 ADXP (Flexural Modulus of 2,150 MPa), all available from the Montell Corporation.

The embodiment which includes a third layer requires a low density polyethylene (not metallocene type). These resins are available from the Dow Chemical Company in densities which may range from 0.918 to 0.928 g/cm³. Melt index values may range from 0.22 to 55 g/10 min, preferably from about 1 to about 8 g/10 min. Representative materials include LDPE 1321, LDPE 5351 and LDPE 6401.

Metallocenes are a class of highly active olefin catalysts employed especially in the preparation of polyethylene and copolyethylene-alpha-olefins. These catalysts, particularly those based on group IV B transition metals, zirconium, titanium and hafnium, show extremely high activity in ethylene polymerization. The metallocene catalysts are also highly flexible in that, by manipulation of catalyst composition and reaction conditions, they can be made to provide polyolefins with controllable molecular weights from as low as about 200 (useful in applications such as lube oil additives) to about 1 million or higher, as for example in ultra high molecular weight linear polyethylene. At the same time, the molecular weight distribution of the polymers can be controlled from extremely narrow (as in a polydispersity, M_{w}/Mₙ of about 2), to broad (a polydispersity of about 8).

An example of a metallocene-based polyolefin that may be used in the first layer is sold under the tradename AFFINITY™ PL 1881 by the Dow Chemical Company. This metallocene-based polyolefin is a plastomer type ethylene-based polymer with a high copolymer content. Plastomers bridge the gap between polyethylenes and elastomers. The density of the polyolefin plastomers is generally from about 0.917 to about 0.865 g/cm³.

The AFFINITY™ PL 1881 resin has a melt index of 1.0 g/10 min. as determined by ASTM D 1238, a density of 0.9035 g/cm³ as determined by ASTM D 792, and a Vicat softening point of 86° C. as determined by ASTM D 1525. The AFFINITY™ PL 1881 resin produces films having low temperature sealability, while having desirable hot tack seal strength.

Another example of a metallocene-based polyethylene that may be used in the first layer is sold under the tradename ELITE™ 5401 by Dow Chemical Company. The ELITE™ 5401 resin has a melt index of 1.0 g/10 min. as determined by ASTM D 1238, a density of 0.9175 g/cm³ as determined by ASTM D 792, and a Vicat softening point of 100° C. as determined by ASTM D 1525. The ELITE™ 5401 resin assists in the processability of the first layer.

Low density polyethylene (non-metallocene derived) is used in the embodiment with a third layer. Suitable polymers in this category include: Paxon AC 45-004 (0.945 density) and Chevron 9503 (0.946 density).

Other ingredients which may be present in one or more layers of the wall laminate of this invention include, but are not limited to, pigments, colorants, antioxidants, slip additives, antiozonants, antifogs, antistats, fillers such as calcium carbonate, diatomaceous earth, carbon black and combinations thereof. These additives may be used in effective amounts, which vary depending upon the property required.

Sheets of the present invention are preferably manufactured through a coextrusion process well known in the plastics art. Overall thickness of the laminate sheets can vary according to the particular utility. Generally the thickness may range from about 0.5 to about 100 mil (0.0125-2.5 min), preferably from about 0.2 to about 10 mil (0.005-0.25 mm).

For definitional purposes, the term “comprising” is meant not to be limiting to any subsequently stated elements but rather to encompass non-specified elements of major or minor functional importance. In other words, the listed steps, elements or options need not be exhaustive.

Except in the operating and comparative examples, or where otherwise explicitly indicated, all numbers in this description indicating amounts of material ought to be understood as modified by the word “about”.

What is claimed is:

1. A package wall comprising:
a first layer comprising at least 50% polypropylene and from 7 to 30% talc each by weight of the first layer; and
a second layer comprising a foamed polypropylene;
wherein the wall has a soft powdery feel and retains a structural memory after being distortedly squeezed.

2. The package wall according to claim 1 wherein the first layer further comprises from about 5 to about 30% by weight of a metallocene polyethylene.

3. The package wall according to claim 2 wherein the first layer comprises from about 15 to about 20% by weight of a metallocene polyethylene.

4. The package wall according to claim 1 wherein the polypropylene is a homopolymer present in an amount from about 55 to about 75% by weight of the first layer.

5. The package wall according to claim 1 wherein talc is present in an amount from about 10 to about 20% by weight of the first layer.

6. The package wall according to claim 1 wherein the second layer is a polypropylene foamed with carbon dioxide and has a density ranging from about 0.3 to about 0.5 g/cm³.

7. The package wall according to claim 1 further comprising a third layer which is a mixture of polypropylene and low density polyethylene in a ratio of about 5:1 to about 1:5 by weight of the third layer.

8. The package wall according to claim 1 wherein the relative weight of the first and second layers range from 1:10 to 1:2.

9. The package wall according to claim 1 wherein the relative weight of the first and second layers ranges from 1:6 to 1:4.

10. The package wall according to claim 8 wherein first and third layers are present in a relative weight ratio of 1:2 to 2:1.
